(19) United States
(12) Patent Application Publication
(10) Pub. No.: US 2009/0101455 A1
(43) Pub. Date: Apr. 23, 2009

(54) SELF-ADJUSTING TORSION LOCK PARKING BRAKE

(75) Inventors: Brian J. Eckerle, Petoskey, MI (US); Ronald J. Hanna, East Jordan, MI (US); Kevin J. Hopp, Gaylord, MI (US)

Correspondence Address: GIFFORD, KRASS, SPRINKLE,ANDERSON & CITKOWSKI, P.C, PO BOX 7021, TROY, MI, 48007-7021, US

(73) Assignee: Dura Global Technologies, Inc.

(21) Appl. No.: 12/182,219

(22) Filed: Jul. 30, 2008

Related U.S. Application Data
(60) Provisional application No. 60/952,912, filed on Jul. 31, 2007.

(51) Int. Cl. G05G 5/00

(52) U.S. Cl. 188/79.54

(57) ABSTRACT

A park brake includes a brake arm movable about a pivot. A release cable is associated with the brake arm for unlocking the brake arm relative to the pivot. A release mechanism is associated with the brake arm, and is positioned about the pivot. A self adjusting mechanism is associated with the brake arm and release cable. The self adjusting mechanism is positioned about the pivot.

### REFERENCE TO RELATED APPLICATIONS

This application claims priority to U.S. provisional patent application No. 60/952,912, which was filed Jul. 31, 2007 and is incorporated herein by reference in its entirety.

### FIELD OF THE INVENTION

The invention relates to parking brake assemblies for motor vehicles. More particularly, the invention relates to self adjusting parking brake assemblies.

### BACKGROUND OF THE INVENTION

Generally, parking brake assemblies for automobiles, among other things, include a lock-release mechanism made up of a sector gear and lock pawl which cooperate to provide a ratcheting type directional locking of the parking brake and an actuator to disengage the lock pawl from the gear sector to release the parking brake or a helical spring. Various self adjusting mechanisms for removing cable slack are generally known in the art to remove cable slack from the brake. Examples of parking brakes can be found in U.S. Pat. Nos. 4,850,242; 5,309,786; 5,881,605; 5,001,942; 5,448,928; 5,211,072; 5,794,492 5,875,688; 5,182,963; 5,588,335; 5,832,784; 5,533,420; 6,662,676, the disclosures of which are herein incorporated by reference.

One of the issues with conventional parking brake systems is that they do not package equally across multiple car platforms. There is, therefore, a need in the art for a parking brake assembly that has improved packaging with sufficient performance such that the system can be more readily adapted across multiple vehicle platforms.

Another issue with conventional brakes is brake lever travel loss. Brake lever travel loss is a term generally understood in the art. Essentially, brake lever travel loss results in the necessity of over applying a parking brake. As such there is a need in the art for a parking brake assembly that has reduced brake lever travel loss.

Another issue with conventional brakes is the complexity and number of components required for operation of the brake assembly. As such there is a need in the art for a parking brake assembly having less complicated assemblies with improved performance parts.

### SUMMARY OF THE INVENTION(S)

In one aspect, there is disclosed a park brake including a brake arm movable about a pivot. A release cable is associated with the brake arm for unlocking the brake arm relative to the pivot. A release mechanism is associated with the brake arm, and is positioned about the pivot. A self adjusting mechanism is associated with the brake arm and release cable. The self adjusting mechanism is positioned about the pivot.

In another aspect, there is disclosed a park brake including a brake arm movable about a pivot. A torsion lock is positioned about the pivot for locking and unlocking the brake lever relative to the pivot. A self adjusting mechanism is positioned about the pivot for adjusting a release cable associated with the brake arm.

### BRIEF DESCRIPTION OF THE DRAWINGS

FIG. 1 is an exploded perspective view of a parking brake;

FIG. 2 is a perspective view of the assembled parking brake;

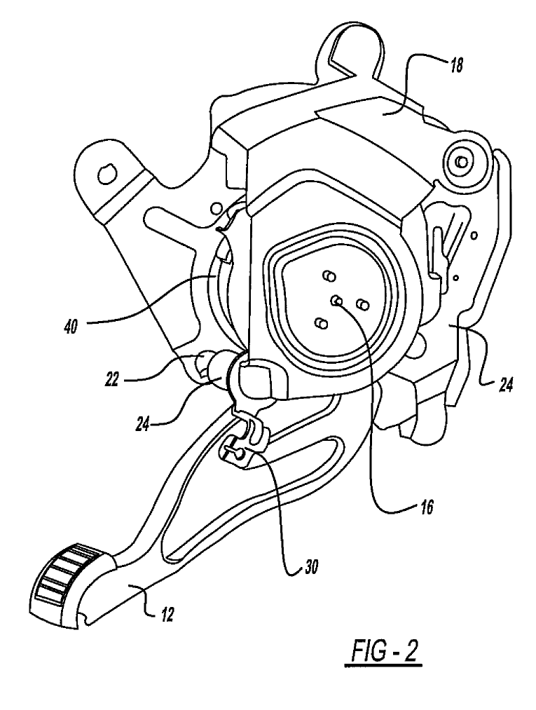

FIG. 3 is a perspective view of the parking brake with the cover plate shown in phantom;

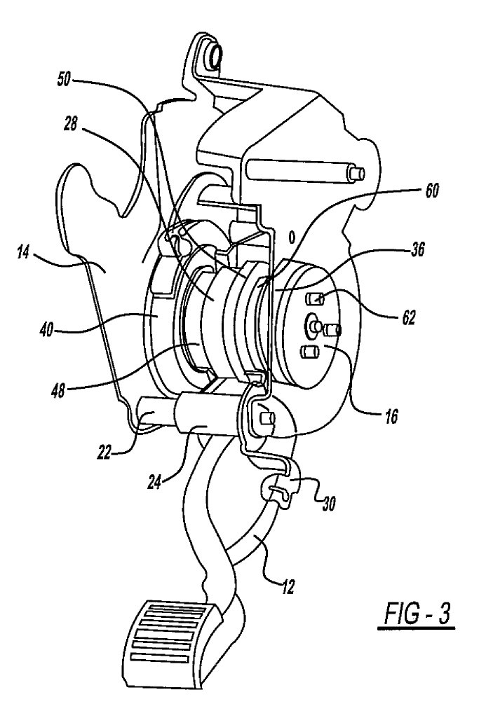

FIG. 4 is a perspective view of a hub and torsion spring;

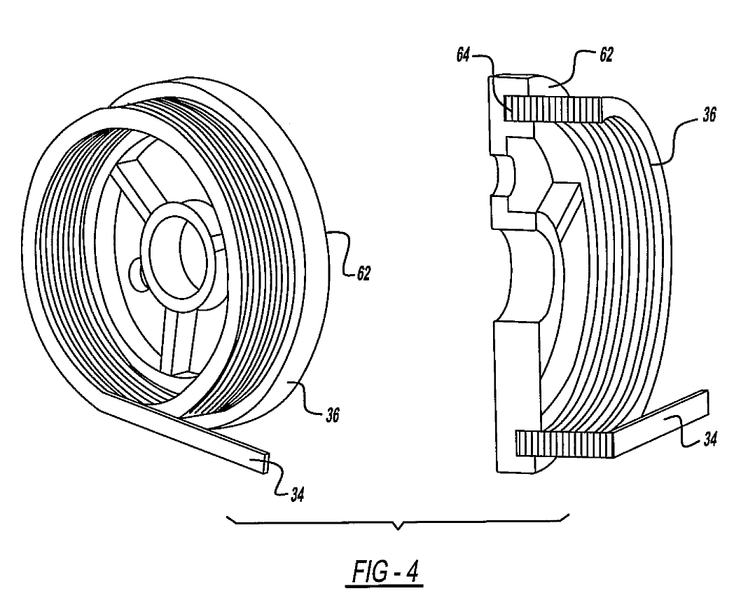

FIG. 5 is a partial sectional view of the parking brake;

FIG. 6 is a side view of the park brake shown in a fully applied position;

FIG. 7 is a partial side view of the parking brake in the brake releasing position detailing the release lever contacting a torsion spring;

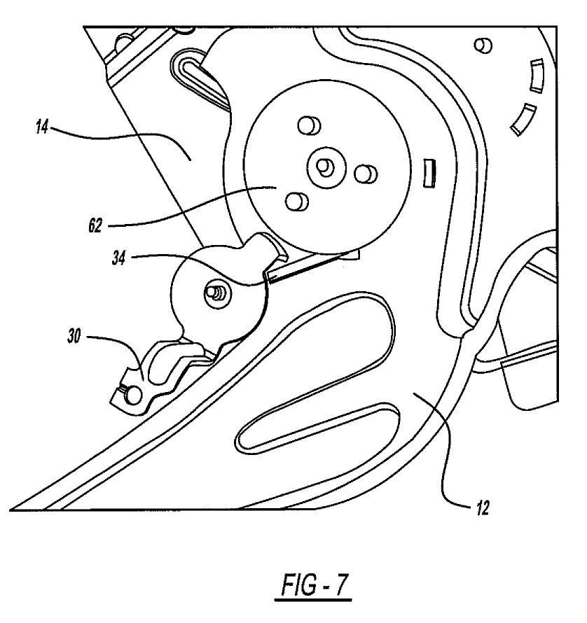

FIG. 8 is a partial perspective view of the parking brake in the home position with the self-adjust torsion spring contacting a bumper rivet allowing the self-adjust mechanism to operate.

### DETAILED DESCRIPTION OF THE PREFERRED EMBODIMENTS

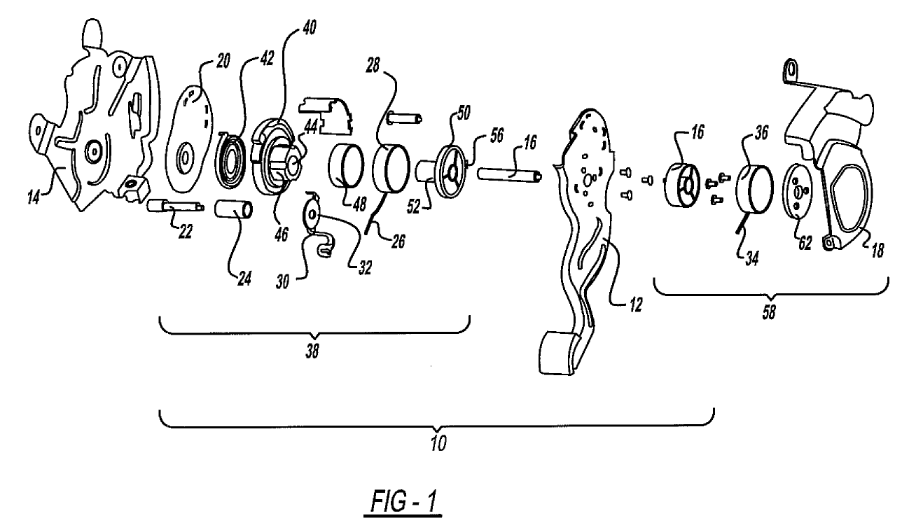

Referring to FIG. 1, there is shown a parking brake 10. The parking brake 10 includes a brake arm 12 that is pivotally connected with a mounting bracket 14 by a pivot pin 16 the ends of which are supported by the mounting bracket 14 and a cover member 18.

A cam plate 20 is attached to the mounting bracket 14. A journal pin or rivet 22 is attached to the mounting bracket 14 at one end and to the cover member 18 at another end. A bumper 24 may be disposed about an outer circumference of the rivet 22 for contacting a leg 26 of a self adjusting torsion spring 28, as will be described in more detail below. Additionally, a release lever 30 is disposed about the rivet 22 for pivotal movement about the rivet 22. The release lever 30 includes a central bore 32 that receives the rivet 22 and has an arcuate shape having one end adapted to receive an end of a brake release cable and another end adapted to contact a leg 34 formed on a torsion lock spring 36.

The cam plate 20 is adapted to receive a self-adjust mechanism 38. The self-adjust mechanism 38 includes a drum track 40 that has a shape adapted to receive a clock spring 42. The drum track 40 includes a central bore 44 having a collar 46 extending longitudinally out from a surface of the drum track 40. A drum sleeve 48 is disposed about the collar 46. The self-adjusting torsion spring 28 is disposed about the drum sleeve 48. The self adjusting spring 28 is positioned such that the inner circumference of the coils contact the drum sleeve 48 and may releasably engage and disengage from the drum sleeve 48. A self-adjust hub 50 is positioned relative to the self-adjusting torsion spring 28 such that the spring 28 is retained between the self-adjust hub 50 and the drum track 40. The self adjust hub 50 includes a projection 52 extending from one side that is received within the bore 44 formed in the drum track 40. Additionally, the self-adjust hub 50 includes a bore 56 formed therein that is positioned about the pivot pin 16 of the park brake 10.

The park brake 10 also includes a locking mechanism 58 positioned on the other side of the brake arm 12 between the brake arm 12 and the cover member 18. The locking mechanism 58 includes a locking hub 60 attached to the brake arm 12. The torsion lock spring 36 is disposed about the locking hub 60 such that the inner circumference of the torsion lock spring 36 contacts an outer circumference of the locking hub 60. A torsion lock spring member 62 is attached to the cover member 18. The torsion lock spring member 62 includes a groove 64 formed thereon into which the locking spring 36 is interference fit keeping one end of the spring fixed in position at all times and eliminating fixed leg stress risers. The torsion lock spring 36 extends to the leg 34 that is adapted to contact the release lever 30, as will be described in more detail below.

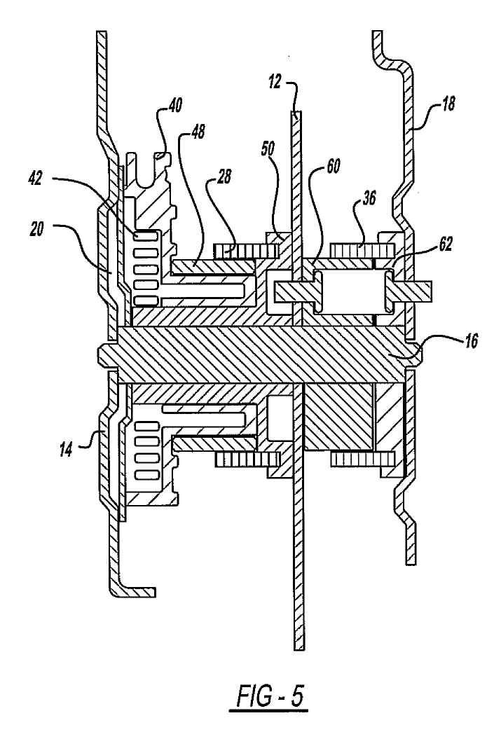

In operation, at a fully released position as shown in FIG. 5, the self adjusting spring 28 is held open by the bumper 24 and rivet 22. In this position, the self adjusting spring 28 associated with the drum track 40 allows the cable track assembly to move relative to the pedal arm 12 at full release to perform a self-adjust function of the brake release cable.

When a force is applied to the brake arm 12, the cable track assembly will rotate with the brake arm 12 such that the self adjusting spring 28 associated with the drum track 40 and drum sleeve 48 tightens its coil radius such that it clutches or contacts the drum sleeve 48 allowing cable to be taken up. Additionally, the torsion lock spring 36 slips on the locking hub 60 until a force is removed from the brake arm 12. When the force is removed from the brake arm 12, the torsion lock spring 36 contacts the locking hub 60 at the inner circumference of the torsion lock spring 36 with the outer circumference of the locking hub 60. In this manner, the brake arm 12 will be held locked in position.

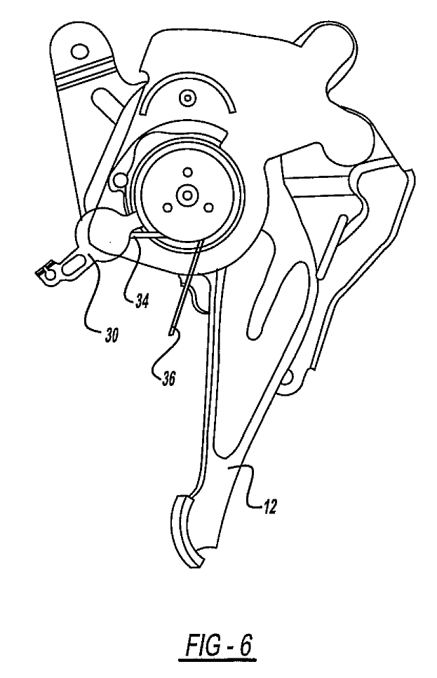

In the fully applied position shown in FIG. 6, the torsion lock spring leg 34 remains in position to release the brake 10 at any time. Additionally at the full applied position, the self-adjust spring leg 26 has rotated with the pedal allowing the self adjusting system to lock and pull cable.

To release the brake arm 12 from the locked position, an operator may pull on a release handle or other mechanism to actuate a release cable rotating the release lever 30 about the rivet 22 such that it contacts the spring leg 34 of the locking spring 36. In this manner, the locking spring 36 is forced to open and increase a radial dimension releasing from contact with the locking hub 60. The brake arm is then free to return to the home position.

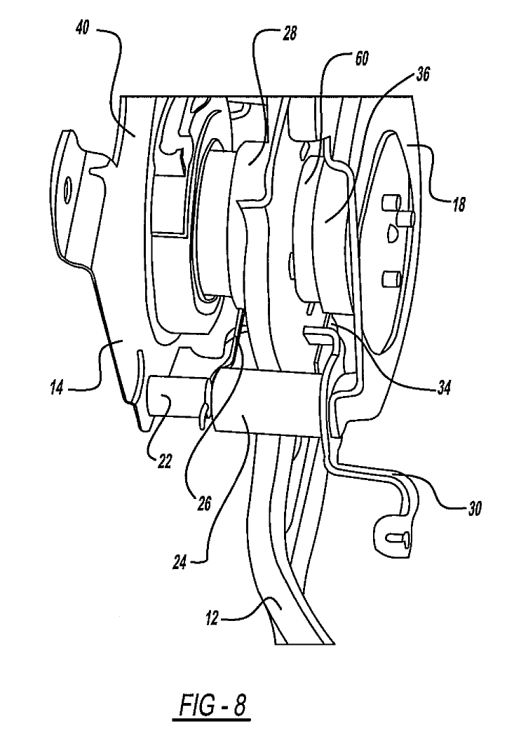

When the brake arm 12 returns to the home position, the self-adjust torsion spring leg 26 contacts the bumper 24 and rivet 22 opening the spring 28 allowing the self-adjust mechanism to take up cable slack as shown in FIG. 8.

1. A park brake comprising:
a brake arm movable about a pivot;
a release cable associated with the brake arm for unlocking the brake arm relative to the pivot;
a release mechanism associated with the brake arm, the release mechanism positioned about the pivot;
a self adjusting mechanism associated with the brake arm and release cable, the self adjusting mechanism positioned about the pivot.

2. The park brake of claim 1 including a mounting bracket attached to a vehicle and a cover plate separated from the mounting bracket, the pivot journaled with the mounting bracket and cover plate at opposing ends of the pivot.

3. The park brake of claim 2 wherein the release mechanism includes a locking hub attached to the brake arm.

4. The park brake of claim 3 including a torsion lock spring disposed about the locking hub such that an inner circumference of the torsion lock spring contacts an outer circumference of the locking hub.

5. The park brake of claim 4 including a torsion lock spring member attached to the cover member, the torsion lock spring member having a groove into which the torsion lock spring is positioned keeping one end of the spring fixed in position and eliminating fixed leg stress risers.

6. The park brake of claim 5 wherein the torsion lock spring extends to a leg that is adapted to contact a release lever for locking and unlocking the torsion lock spring relative to the locking hub.

7. The park brake of claim 2 including a rivet attached to the mounting bracket at one end and to the cover member at another end, the rivet including a bumper disposed about an outer circumference of the rivet.

8. The park brake of claim 7 including a release lever disposed about the rivet for pivotal movement about the rivet, the release lever including a central bore that receives the rivet and has an arcuate shape having one end adapted to receive an end of a brake release cable and another end adapted to contact a leg formed on a torsion lock spring.

9. The park brake of claim 2 including a cam plate attached to the mounting bracket, the cam plate adapted to receive a self-adjust mechanism.

10. The park brake of claim 9 including a drum track that has a shape adapted to receive a clock spring, the drum track including a central bore having a collar extending longitudinally out from a surface of the drum track.

11. The park brake of claim 10 including a drum sleeve disposed about the collar.

12. The park brake of claim 11 including a self-adjusting torsion spring disposed about the drum sleeve, the self adjusting spring positioned such that the inner circumference contacts the drum sleeve and releasably engages and disengages from the drum sleeve.

13. The park brake of claim 12 including a self-adjust hub having a bore formed therein that is positioned about the pivot of the park brake.

14. The park brake of claim 13 wherein the self-adjust hub positioned relative to the self-adjusting torsion spring such that the self adjusting spring is retained between the self-adjust hub and the drum track.

15. The park brake of claim 14 wherein the self adjust hub includes a projection extending from one side that is received within the bore formed in the drum track.

16. A park brake comprising:
a brake arm movable about a pivot;
a torsion lock positioned about the pivot for locking and unlocking the brake lever relative to the pivot;
a self adjusting mechanism positioned about the pivot for adjusting a release cable associated with the brake arm.

17. The park brake of claim 16 including a mounting bracket attached to a vehicle and a cover plate separated from the mounting bracket, the pivot journaled with the mounting bracket and cover plate at opposing ends of the pivot, and a cam plate attached to the mounting bracket.

18. The park brake of claim 17 including a drum track that has a shape adapted to receive a clock spring, the drum track including a central bore having a collar extending longitudinally out from a surface of the drum track and a drum sleeve disposed about the collar, and a self-adjusting torsion spring disposed about the drum sleeve, the self adjusting spring positioned such that the inner circumference contacts the drum sleeve and releasably engages and disengages from the drum sleeve.

19. The park brake of claim 18 including a self-adjust hub having a bore formed therein that is positioned about the pivot of the park brake and wherein the self-adjust hub is positioned relative to the self-adjusting torsion spring such that the self adjusting spring is retained between the self-adjust hub and the drum track.

20. The park brake of claim 16 including a locking hub attached to the brake arm, the torsion lock spring disposed about the locking hub such that an inner circumference of the torsion lock spring contacts an outer circumference of the locking hub and a torsion lock spring member attached to a cover member, the torsion lock spring member having a groove into which the torsion lock spring is positioned keeping one end of the spring fixed in position and eliminating fixed leg stress risers.
